(19) United States
(12) Patent Application Publication
(10) Pub. No.: US 2010/0326364 A1
(43) Pub. Date: Dec. 30, 2010

(54) ANIMAL EUTHANASIA DEVICES

(75) Inventors: Stephen Welbourne, Pittsfield, IL (US); Keith Elledge, Pittsfield, IL (US); Randy Gress, Milton, IL (US)

Correspondence Address: David S. D'Ascenzo;DASCENZO INTELLECTUAL PROPERTY LAW, P.C., Suite 925, 522 S.W. 5th Avenue, Portland, OR, 97204, US

(73) Assignee: Welbourne Innovations, Inc., Pittsfield, IL (US)

(21) Appl. No.: 12/820,985

(22) Filed: Jun. 22, 2010

Related U.S. Application Data
(60) Provisional application No. 61/269,471, filed on Jun. 24, 2009.

(51) Int. Cl. A01K 29/00

(52) U.S. Cl. 119/174

(57) ABSTRACT

Animal euthanasia devices include an animal receiving region, a user input mechanism operatively connected to the animal receiving region, and a control system configured to be operatively connected to a current source. The control system is configured to selectively permit current to flow from the current source through an animal to be euthanized that is positioned within the animal receiving region to effectively and humanely euthanize the animal.

### RELATED APPLICATION

This application claims priority to U.S. Provisional Patent Application Ser. No. 61/269,471, which was filed on Jun. 24, 2009, and the complete disclosure of which is hereby incorporated by reference.

### FIELD OF THE DISCLOSURE

The present disclosure is directed to animal euthanasia devices, and more particularly to animal euthanasia devices that use electricity to effectively and humanely euthanize animals.

### BACKGROUND OF THE DISCLOSURE

In the practice of animal husbandry, it is an unfortunate fact than a percentage of offspring may be born with diseases, may develop diseases in the early days of their lives, or may otherwise not be fit for raising to maturity for one reason or another.

### SUMMARY OF THE DISCLOSURE

Animal euthanasia devices according to the present disclosure include an animal receiving region, a user input mechanism operatively connected to the animal receiving region, and a control system configured to be operatively connected to a current source. The control system is configured to selectively permit current to flow from the current source through an animal to be euthanized that is positioned within the animal receiving region to effectively and humanely euthanize the animal.

### BRIEF DESCRIPTION OF THE DRAWINGS

FIG. 1 is a schematic diagram representing examples of animal euthanasia devices according to the present disclosure.

FIG. 2 is fragmentary front view of an illustrative, non-exclusive example of an animal euthanasia device according to the present disclosure.

FIG. 3 is a fragmentary front view of the animal euthanasia device of FIG. 2, illustrated with its door in an open position.

FIG. 4 is a fragmentary side view of the animal euthanasia device of FIG. 2, illustrated with its door in an open position and its animal receiving region in an open configuration, together with a schematic representation of an animal to be euthanized.

FIG. 5 is fragmentary side view of the animal euthanasia device of FIG. 2, illustrated with its door in a closed position and its animal receiving region within its range of animal receipt configurations.

FIG. 6 is an illustrative, non-exclusive example of a schematic wiring diagram associated with animal euthanasia devices according to the present disclosure.

### DETAILED DESCRIPTION AND BEST MODE OF THE DISCLOSURE

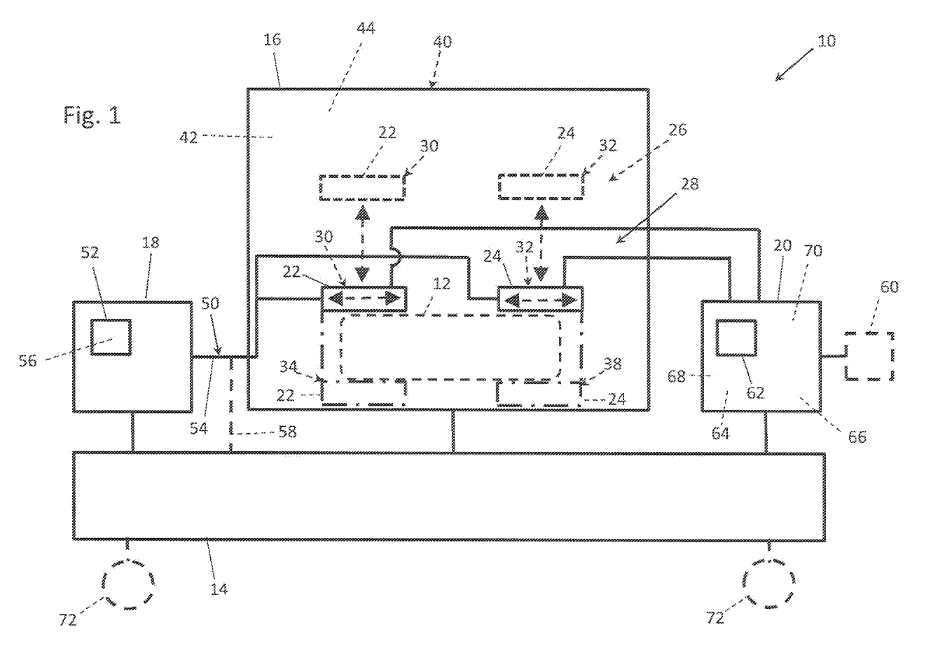

Animal euthanasia devices according to the present disclosure are schematically illustrated in FIG. 1 and are indicated generally at 10. Animal euthanasia devices 10 are designed to effectively and humanely euthanize animals through utilization of electric shock. An animal to be euthanized is schematically represented in FIG. 1 at 12. Animal euthanasia devices 10 according to the present disclosure include a frame 14, an animal receiving region 16, a user input mechanism 18, and a control system 20. The animal receiving region, the user input mechanism, and optionally the control system are supported, directly or indirectly, and fully or partially, by the frame, as schematically illustrated in FIG. 1.

Animal receiving region 16 is a region that is configured to receive and support an animal to be euthanized. The animal receiving region may be defined by various structure, including (but not limited to) an enclosure, a partial enclosure, a table top, electrodes, supports, and/or any other suitable structure. Animal receiving regions according to the present disclosure include at least a positive electrode 22 and a negative electrode 24 spaced apart from the positive electrode. As schematically illustrated in FIG. 1, both electrodes are positioned to engage an animal to be euthanized. The animal receiving region includes an open configuration 26, in which the animal receiving region is configured to receive an animal to be euthanized. The positive electrode and the negative electrode are schematically illustrated in dashed lines in an open configuration and spaced apart from the animal to be euthanized, thus forming a configuration of the animal receiving region in which an animal to be euthanized may be appropriately positioned in the animal receiving region. As discussed herein, however, it is also within the scope of the present disclosure that the electrodes are stationary with respect to the animal receiving region, and other structure may be spaced so as to permit the animal to be euthanized to be appropriately positioned in the animal receiving region and into engagement with the electrodes.

The animal receiving region also includes a range of animal receipt configurations 28, in which the animal receiving region is configured to restrict movement of the animal to be euthanized. This is schematically illustrated in FIG. 1 with positive electrode 22 and negative electrode 24 schematically illustrated in solid lines within the range of animal receipt configurations and engaged with the animal to be euthanized 12. The animal euthanasia device is configured to effectively and humanely euthanize animals of various sizes, and therefore the animal receiving region includes a range of animal receipt configurations. In some embodiments (although not required), the animal receiving region may be biased toward the range of animal receipt configurations. In some embodiments the electrodes may be pressed against the animal to be euthanized when the animal receiving region is in the range of animal receipt configurations and the animal to be euthanized is appropriately positioned therein. Additionally or alternatively, as discussed herein, additional or alternative structure may be pressed against the animal to be euthanized.

FIG. 1 schematically illustrates the electrodes as being movable between the open configuration and the range of animal receipt configurations; however, it is also within the scope of the present disclosure that the electrodes may be stationary with respect to the animal receiving region and/or the frame of the animal euthanasia device, and another structure may translate, or otherwise move, between the open configuration and the range of animal receipt configurations. As an illustrative, non-exclusive example, positive electrode 22 and negative electrode 24 are schematically illustrated in FIG. 1 in dash-dot lines in a stationary position, and the structure schematically identified at 30 and 32 may be described as supports, or support pads, configured to engage the animal to be euthanized and to be translated between the open configuration and the range of animal receipt configurations of the animal receiving region.

In some embodiments, the animal receiving region may be described as including a lower left support 34, an upper left support 30 positioned above the lower left support, a lower right support 38, and an upper right support 32 positioned above the lower right support. In such embodiments, the left supports may be positioned to engage a first portion of an animal to be euthanized, and the right supports may be positioned to engage a second portion of an animal to be euthanized. As an illustrative, non-exclusive example, the first portion of the animal to be euthanized may correspond to the animal's head, and the second portion of the animal to be euthanized may correspond to a region of the animal on the opposite side of the animal's heart from the animal's head, such as (but not limited to) including the rearward most rib of the animal. Other configurations are also within the scope of the present disclosure.

In embodiments including upper and lower supports, at least one of the left supports includes one of the positive electrode and the negative electrode, and at least one of the right supports includes the other of the positive electrode and the negative electrode. In the schematic illustration of FIG. 1, at least one of the left supports corresponds to, and/or includes, positive electrode 22, and at least one of the right supports corresponds to, and/or includes, negative electrode 24; however, it is also within the scope of the present disclosure that at least one of the left supports corresponds to, and/or includes, the negative electrode, and at least one of the right supports corresponds to the positive electrode. Additionally or alternatively, the electrodes may be described as including the supports.

Additionally or alternatively, the lower left support and the upper left support may be at least partially constructed of conductive material and be electrically coupled to each other, thereby collectively defining, and/or including, one of the electrodes, as schematically illustrated in dash-dot lines in FIG. 1. Similarly, the lower right support and the upper right support may be at least partially constructed of conductive material and be electrically coupled to each other, thereby collectively defining, and/or including, the other one of the electrodes, as schematically illustrated in dash-dot lines in FIG. 1.

Additionally or alternatively, as schematically illustrated in FIG. 1 and indicated with the double-headed dashed arrows within the upper supports, an animal receiving region according to the present disclosure may be adjustable to accommodate animals of various lengths and/or widths. While FIG. 1 schematically illustrates the upper supports being adjustable, other configurations are also within the scope of the present disclosure.

In some embodiments, an animal euthanasia device 10 according to the present disclosure may include an enclosure 40 supported by frame 14 and defining an internal volume 42. In some such embodiments, the enclosure may at least partially define the animal receiving region. Additionally or alternatively, the animal receiving region may be at least partially disposed within the enclosure. Additionally or alternatively, the enclosure, when present, may be described as a component of the frame.

In optional embodiments that include enclosure 40, the enclosure may include a door 44 operative (i.e., configured to be selectively positioned) between an open position and a closed position. When present and in the open position, the animal to be euthanized can be positioned in and removed from the animal receiving region, and when in the closed position, the animal to be euthanized may be restricted from being positioned in and removed from the animal receiving region. Stated differently, when present, the door may selectively provide access in the internal volume of the enclosure and thus to the animal receiving region. Likewise, when closed, the door may cooperate with the enclosure to prevent or otherwise restrict access into or out of the internal volume of the enclosure, such as into or out of the animal receiving region.

In some embodiments, animal receiving regions according to the present disclosure may be specifically configured to receive an animal to be euthanized on its side (i.e., the left or right side of the animal if the animal were standing). Accordingly, the electrodes and/or the supports may be shaped, or otherwise configured (fixedly or adjustably), to engage the sides (or other suitable body portions) of the animal to be euthanized. Accordingly, although not required, one or more of the electrodes and/or the supports, when present, may be contoured to provide for effective surface contact with the animal and reduced electrical resistance between the electrodes and the body of the animal to be euthanized.

In some embodiments, the animal receiving region may be configured to receive a piglet of about 3-4 days old. In some such configurations, the portions of the piglet which the electrodes are positioned to engage may include at least an ear of the piglet and at least a portion of the piglet corresponding to a rearward most rib of the piglet. Other animals and ages and sizes of animals to be euthanized are also within the scope of the present disclosure. For example, animal receiving regions may be sized and configured to receive animals, including piglets, of about 3-4 days old, of less than 3 days old, and/or of greater than 3-4 days old. Additionally or alternatively, an animal receiving region may be sized to receive an animal of about 0.25-60 pounds, including animals of about 0.25, 0.5, 0.75, 1, 2, and 3 or more pounds. It is within the scope of the present disclosure that sizes and ages that are smaller than, larger than, or within the enumerated ranges presented above, may be used without departing from the scope of the present disclosure.

Prior to being positioned within the animal receiving region and into engagement with the electrodes, it may be desirable (although not required in all embodiments) to spray, or otherwise coat, the portions of the animal to be euthanized that will be engaged with the electrodes with a conductive paste, gel, or other material that is configured to provide an increased electrical connection between the animal's skin and the electrodes.

As schematically illustrated in FIG. 1, user input mechanism 18 is operatively connected to animal receiving region 16. The user input mechanism is configured to reconfigure the animal receiving region between the open configuration and the range of animal receipt configurations in response to user engagement of the user input mechanism.

User input mechanism 18 may include a linkage assembly 50 including one or more user engagement structures 52 positioned to be engaged by a user of animal euthanasia device 10, and a mechanical linkage 54 supported by frame 14 and operatively connecting the user engagement structure(s) to the animal receiving region, as schematically illustrated in FIG. 1. When the user engagement structure(s) is/are engaged by the user, the mechanical linkage causes the animal receiving region to reconfigure from the range of animal receipt configurations to the open configuration, and when the user engagement structure(s) is/are disengaged by the user, the mechanical linkage causes the animal receiving region to reconfigure from the open configuration to the range of animal receipt configurations.

In some embodiments, the user engagement structure may include one or more foot pedals 56 positioned to be engaged by a user's foot. In such embodiments, when a user presses down on the foot pedal(s) with the user's foot, the animal receiving region reconfigures from the range of animal receipt configurations to the open configuration, and when a user removes the user's foot from the foot pedal(s), the animal receiving region reconfigures from the open configuration to the range of animal receipt configurations. Accordingly, when present, the foot pedal(s) may be biased in an upward direction. An additional illustrative, non-exclusive example of suitable user engagement structures includes hand levers, but other configurations and forms of user engagement structures are also within the scope of the present disclosure.

In some embodiments, linkage assembly 50 may include a spring 58, or other biasing mechanism, that is supported, either directly or indirectly, between the frame and the mechanical linkage and that biases the animal receiving region toward the range of animal receipt configurations. Additionally or alternatively, the weight of at least a portion of the animal receiving region (e.g., the supports and/or the electrodes) may at least partially bias the animal receiving region toward the range of animal receipt configurations. The spring and/or the weight of at least a portion of animal receiving region 16 may apply approximately 3-8 pounds of force against the animal to be euthanized, but forces outside of this range (including forces that are greater than or less than this range) are also within the scope of the present disclosure.

In some embodiments that include an upper left support 30 and an upper right support 32, mechanical linkage 54 may operatively connect user engagement structure 52 to the upper left support and the upper right support. Accordingly, when the user engagement structure is engaged by a user, the mechanical linkage causes the upper left support and the upper right support to translate upward (or otherwise away from an animal that is properly positioned in the animal receiving region), thereby reconfiguring the animal receiving region from the range of animal receipt configurations to the open configuration. Conversely in such embodiments, when the user engagement structure is disengaged by the user, the mechanical linkage causes the upper left support and the upper right support to translate downward (or otherwise toward an animal that is properly positioned in the animal receiving region), thereby reconfiguring the animal receiving region from the open configuration to the range of animal receipt configurations.

In some embodiments, the animal euthanasia device may be configured so that the upper left support 30 and the upper right support 32 translate independent of each other and thus independently apply pressure to the respective portions of an animal to be euthanized. Such a configuration may be suitable for an animal having portions that are of different widths, such as the animal's head and the portion of the animal corresponding to the rearward most rib. Such a configuration may be accomplished in any suitable manner. For example, two user engagement structures 52 may be provided, with each user engagement structure respectively and operatively being connected to one of the upper left support and the upper right support. In such an embodiment, the upper left support and the upper right support may be independently controlled by a user. Additionally or alternatively, a single user engagement structure may operate both of the upper left support and the upper right support, and the linkage assembly 50 and/or the mechanical linkage 54 may be configured so that the upper left support and the upper right support translate independently with respect to each other but in direct response to user engagement of a single user engagement mechanism. Other configurations are also within the scope of the present disclosure.

As schematically illustrated in FIG. 1, control system 20 is configured to be operatively connected to a current source 60, such as (but not limited to) a standard North American 120 Volt alternating current (AC) wall socket or a standard European 230 Volt alternating current (AC) wall socket. Other current sources are also within the scope of the present disclosure, including direct current (DC) current sources, and current sources having voltages other than the enumerated values above.

Control systems 20 according to the present disclosure include an activation mechanism 62 configured to be engaged by a user, such that in response to the user engaging the user engagement mechanism, the control system is configured to selectively permit, or enable, or cause, current to flow from the current course through negative electrode 24, positive electrode 22, and the animal to be euthanized 12, when the animal to be euthanized is received in the animal receiving region and engaged by the positive electrode and the negative electrode. Stated differently, the control system is configured to selectively close a circuit that includes the positive electrode, the negative electrode, and the animal to be euthanized. In other words, the user engagement mechanism permits, or enables, a user to configure animal euthanasia device 10 to a state in which current flows through the animal to be euthanized, and to thereby effectively and humanely euthanize an animal. Illustrative, non-exclusive examples of user engagement mechanisms include buttons, switches, levers, foot pedals, etc. suitably configured to receive user input.

In some embodiments, control system 20 further includes a timer 64 configured to stop, or otherwise prevent, current from flowing after a predetermined time has elapsed from the user engagement mechanism having been engaged by a user. As illustrative, non-exclusive examples, the predetermined length of time may be in the range of about 1-30, 3-5, 3-10, 8-10, 5-15, and 10-15 seconds, including (but not limited to) lengths of time equal to about 3, 5, 10, 15, or 20 seconds. Other lengths of time greater than or less than, as well as within, the enumerated ranges and values are within the scope of the present disclosure. Additionally or alternatively, the predetermined length of time may be adjustable by a user, for example, to permit, or enable, for adjustment based on the size, age, and/or type of animal to be euthanized. Accordingly, the control system may (but is not required to) include a timer adjustment mechanism 66 positioned to be engaged by a user and configured to adjust the predetermined length of time.

Depending on the type, size, and/or age of the animal to be euthanized, the control system may be configured so that about 2-3 amps of current flow through the animal to be euthanized, but amperages outside (i.e., greater than or less than) of this range are also within the scope of the present disclosure. Depending on the type, size, and/or age of the animal to be euthanized and the predetermined length of time of the current, the animal to be euthanized may be effectively and humanely euthanized due to an electrical arc produced within the animal's body and through its brain and heart.

Additionally or alternatively, a control system 20 according to the present disclosure may include a switch, or safety switch, 68 that restricts current from flowing from the current source through the electrodes and the animal to be euthanized regardless of the user engaging the activation mechanism, unless a predetermined condition is present. For example, in optional embodiments that include an enclosure having a door operative between an open position and a closed position, as discussed herein, the predetermined condition may include the door being in the closed position. In other words, the control system may be configured to restrict a user from euthanizing an animal unless the door to the enclosure is closed and the user is restricted from being able to place his/her hands within the enclosure, from being able to touch the animal to be euthanized, and from being able to touch the electrodes. Other configurations of safety switches are also within the scope of the present disclosure, including (but not limited to) a second engagement mechanism, such as a button, that must be engaged at the same time as the user engagement mechanism in order for the control system to permit current to flow through the electrodes.

In some embodiments, control system 20 may additionally or alternatively include a light 70 positioned to be viewed by a user of the euthanasia device. Control system 20 may illuminate the optional light when current is permitted, or enabled, to flow through the electrodes. Alternatively, the control system may illuminate the light when current is restricted from flowing through the electrodes. Additionally or alternatively, the control system may include a timer associated with light 70,

In some embodiments, euthanasia device 10 may be configured to be portable, such as (but not limited to) including a plurality of wheels 72 supported by frame 14.

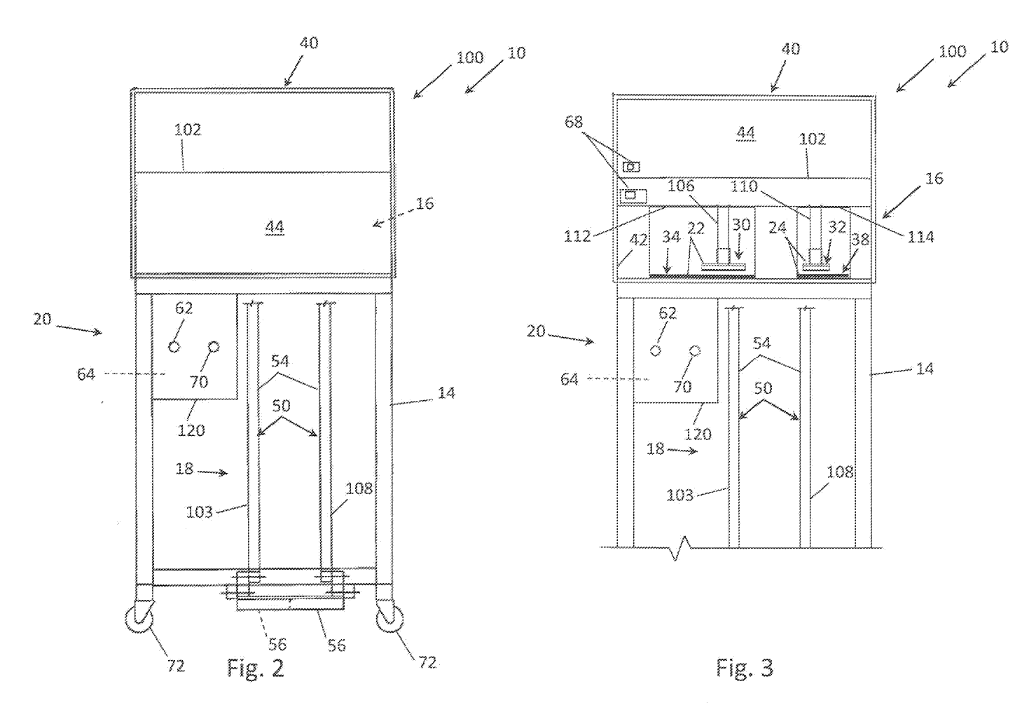

An illustrative, non-exclusive example of an animal euthanasia device 10 according to the present disclosure is somewhat less schematically illustrated in FIGS. 2-5, and is indicated generally at 100. Where appropriate, the reference numerals from the schematic illustration of FIG. 1 are used to designate corresponding parts of animal euthanasia device 100; however, the example of FIGS. 2-5 are non-exclusive and do not limit the present disclosure to the illustrated embodiment. That is, neither animal euthanasia devices according to the present disclosure nor various component parts thereof are limited to the specific embodiment disclosed and illustrated in FIGS. 2-5, and animal euthanasia devices 10 according to the present disclosure may incorporate any number of the various aspects, configurations, characteristics, properties, etc. illustrated and described with respect to the embodiment of FIGS. 2-5, as well as variations thereof and without requiring the inclusion of all such aspects, configurations, characteristics, properties, etc. For the purpose of brevity, each previously discussed component part, or variant thereof, may not be discussed again with respect to FIGS. 2-5; however, it is within the scope of the present disclosure that the previously discussed features, variants, etc. may be utilized with the embodiment of FIGS. 2-5. Similarly it is also within the scope of the present disclosure that all of the component parts, and portions thereof, that are illustrated in FIGS. 2-5 are not required to all embodiments according to the present disclosure.

As seen in FIGS. 2-5, animal euthanasia device 100 is an example of an animal euthanasia device 10 according to the present disclosure that includes an enclosure 40 having a door 44. Device 100 includes a hinge 102 that couples the door to the remainder of the enclosure, and thereby permits the door to be selectively positioned between its closed position, as illustrated in FIG. 2, and its open position, as illustrated in FIG. 3, to reveal the internal volume 42 of the enclosure and to provide access to the animal receiving region 16. Other configurations are also within the scope of the present disclosure, including doors that slide relative to the enclosure, doors that are removable, etc.

The animal receiving region of animal euthanasia device 100 includes an upper left support member 30 and a lower left support member 34 that collectively define positive electrode 22, and an upper right support member 32 and a lower right support member 38 that collectively define negative electrode 24. Alternatively, the upper left support member 30 and the lower left support member 34 may collectively define a negative electrode, and the upper right support member 32 and the lower right support member 38 may collectively define a positive electrode. For purposes of this discussion of euthanasia device 100, the electrodes will be described in terms of a left electrode 22 and a right electrode 24.

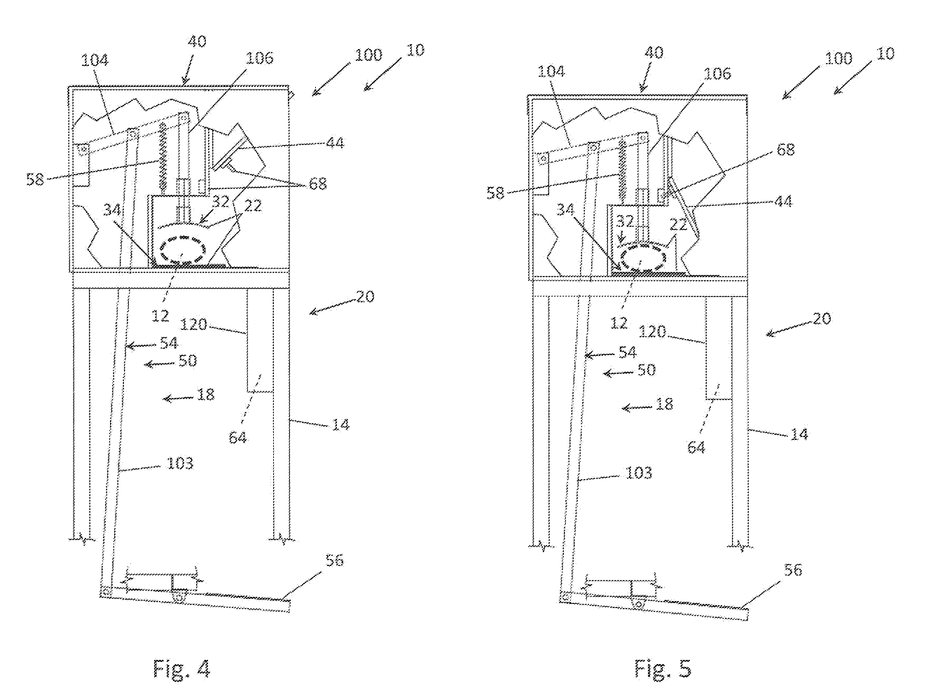

Animal euthanasia device 100 includes a user input mechanism 18 that includes a linkage assembly 50. The linkage assembly includes a foot pedal 56 and a mechanical linkage 54 that operatively connects the foot pedal to the animal receiving region, and more specifically that operatively connects the foot pedal to the upper supports 30, 32, as perhaps best seen in FIGS. 4-5. Specifically, mechanical linkage 54 includes a left rear link 103 hingedly coupled between foot pedal 56 and a left upper link 104. Left upper link 104 is hingedly coupled between frame 14 and a left forward link 106, which has the upper left support disposed on a lower end thereof. Similarly, mechanical linkage 54 includes a right rear link 108 hingedly coupled between foot pedal 56 and a right upper link. The right upper link is hingedly coupled between frame 14 and a right forward link 110, which has the upper right support 32. While not illustrated in the Figures, the right upper link is substantially similar to left upper link 104 shown in FIGS. 4-5. The upper links are electrically isolated from the frame and the rear links; however, they are electrically coupled to the forward links. Additionally, the lower left support 34 is electrically coupled to a left upper plate 112, and a left spring 58 is connected between the left upper plate and the left upper link. Accordingly, the left forward link, and the left upper support 30, which is disposed on the lower end of the left forward link, is biased downward. Similarly, the lower right support 38 is electrically coupled to a right upper plate 114, and a right spring 58 is connected between the right upper plate and the right upper link. Accordingly, the right forward link, and the right upper support 32, which is disposed on the lower end of the right forward link, is biased downward.

Accordingly, as can be seen in the sequence of FIGS. 3-5, the animal receiving region 16 may be reconfigured from within the range of animal receipt configurations (FIG. 3) to the open configuration (FIG. 4), in which an animal to be euthanized 12 may be appropriately positioned within the enclosure 40 and on top of the lower supports 34, 38, in response to a user stepping on foot pedal 56. Then once the animal to be euthanized is appropriately positioned, and the user releases his/her foot from the foot pedal and due to the bias of the springs 58 and the weight of the forward links and the upper supports, the animal receiving region will reconfigure to the range of animal receipt configurations. If an animal to be euthanized was appropriately positioned, the upper supports engage the animal. As a result, the left and right electrodes are electrically coupled to each other via the animal to be euthanized.

As indicated in dashed lines in FIG. 2, it is within the scope of the present disclosure that an animal euthanasia device 100 may include two foot pedals 56, with each foot pedal independently operating left rear link 103 and right rear link 108, and therefore independently operating upper left support 30 and upper right support 32. Other configurations for independent operation of the upper supports are also within the scope of the present disclosure.

The control system 20 of animal euthanasia device 100 is at least partially disposed within a housing 120 supported by the frame of the device, as seen in FIGS. 2-5. The housing supports an activation mechanism 62, in the form of a button, and a light 70. The control system of device 100 also includes a safety switch 68, which prevents the flow of current through the electrodes when door 44 is in an open position (FIGS. 3-4), and permits the flow of current through the electrodes when the door is in a closed position (FIGS. 2 and 5).

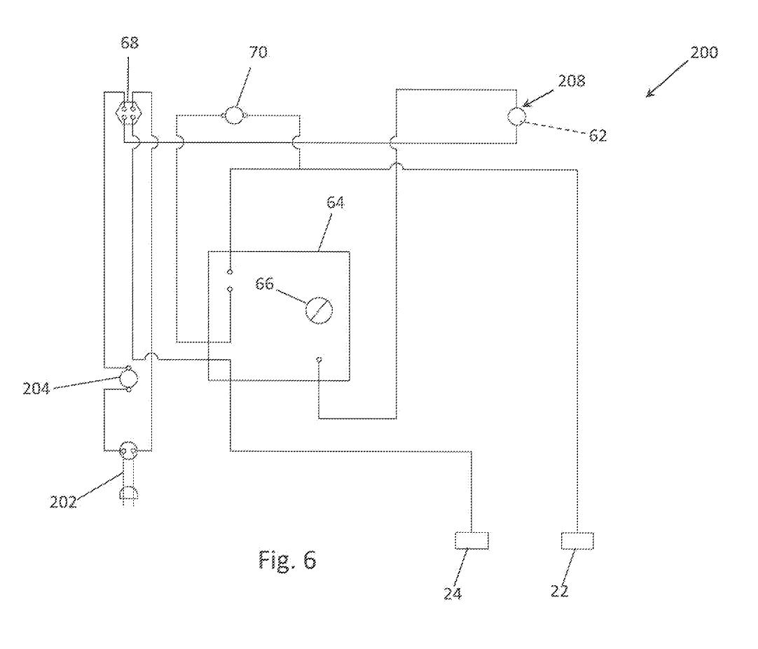

Turning now to FIG. 6, an illustrative, non-exclusive example of a wiring diagram 200 associated with animal euthanasia devices according to the present disclosure, optionally including animal euthanasia device 100 of FIGS. 2-5, is presented. Additionally or alternatively, the wiring diagram may be described as a schematic representation of a control system 20 according to the present disclosure. With reference to FIG. 6, the wiring diagram includes a power cord 202 for electrically receiving current from a current source, a circuit breaker 204, safety switch 68, a start switch 208, which may be, may include, or may be operatively coupled to, the activation mechanism 62, light 70, timer 64, timer adjustment mechanism 66, positive electrode 22, and negative electrode 24. Other configurations are also within the scope of the present disclosure, and the euthanasia devices 10 according to the present disclosure are not limited to the wiring diagram of FIG. 6. For example, wiring diagrams without one or more of the optional circuit breaker, the optional light, the optional timer, the optional timer adjustment mechanism, etc. are within the scope of the present disclosure.

The following enumerated paragraphs represent illustrative, non-exclusive ways of describing animal euthanasia devices according to the present disclosure.

A An animal euthanasia device, comprising:

a frame;

an animal receiving region supported by the frame and including:
a positive electrode positioned to engage an animal to be euthanized;
a negative electrode spaced apart from the positive electrode and positioned to engage the animal to be euthanized;
wherein the animal receiving region includes an open configuration, in which the animal receiving region is configured to receive the animal to be euthanized, and a range of animal receipt configurations, in which the animal receiving region is configured to restrict movement of the animal to be euthanized;

a user input mechanism supported by the frame and operatively connected to the animal receiving region, wherein in response to user actuation of the user input mechanism the user input mechanism is configured to selectively reconfigure the animal receiving region from within the range of animal receipt configurations to the open configuration to permit a user to position the animal to be euthanized within the animal receiving region and engaged by the positive electrode and the negative electrode, and to selectively reconfigure the animal receiving region from the open configuration to within the range of animal receipt configurations to retrain the animal to be euthanized within the animal receiving region;

a control system configured to be operatively connected to a current source, the control system including an activation mechanism configured to be engaged by the user, wherein in response to the user engaging the user activation mechanism the control system is configured to selectively permit current to flow from the current source through the negative electrode, the positive electrode, and the animal to be euthanized when the animal to be euthanized is received in the animal receiving region and engaged by the positive electrode and the negative electrode.

A0 The animal euthanasia device of paragraph A, wherein the animal receiving region is biased toward the range of the animal receipt configurations.

A1 The animal euthanasia device of any of paragraphs A-A0,

wherein the animal receiving region includes:
a lower left support;
an upper left support positioned above the lower left support;
a lower right support; and
an upper right support positioned above the lower right support;
wherein the lower left support and the upper left support are configured to engage a first portion of the animal to be euthanized when the animal receiving region is in the range of animal receipt configurations and the animal to be euthanized is received in the animal receiving region;
wherein the lower right support and the upper right support are configured to engage a second portion of the animal to be euthanized when the animal receiving region is in the range of animal receipt configurations and the animal to be euthanized is received in the animal receiving region, wherein the second portion of the animal to be euthanized is spaced from the first portion of the animal to be euthanized; and
wherein at least one of the lower left support and the upper left support include one of the positive electrode and the negative electrode, and at least one of the lower right support and the upper right support include the other of the positive electrode and the negative electrode.

A1.1 The animal euthanasia device of paragraph A1,

wherein the lower left support and the upper left support are constructed of a conductive material, are electrically coupled to each other, and collectively define one of the positive electrode and the negative electrode; and

wherein the lower right support and the upper right support are constructed of a conductive material, are electrically coupled to each other, and collectively define the other of the positive electrode and the negative electrode.

A1.2 The animal euthanasia device of any of paragraphs A1-A1.1, wherein the positive electrode includes the lower left support and the upper left support, and the negative electrode includes the lower right support and the upper right support.

A1.3 The animal euthanasia device of any of paragraphs A1-A1.1, wherein the positive electrode includes the lower right support and the upper right support, and the negative electrode includes the lower left support and the upper left support.

A1.4 The animal euthanasia device of any of paragraphs A1-A1.3, wherein when the animal receiving region is reconfigured from the open configuration to the range of animal receipt configurations, the upper left support translates toward the lower left support and the upper right support translates toward the lower right support.

A1.5 The animal euthanasia device of any of paragraphs A1-A1.4, wherein the lower left support and the lower right support are stationary relative to the frame.

A1.6 The animal euthanasia device of any of paragraphs A1-A1.5, wherein one of the first portion and the second portion includes an ear of the animal to be euthanized and the other of the first portion and the second portion includes a rearward most rib of the animal to be euthanized.

A1.6.1 The animal euthanasia device of paragraph A1.6, wherein the animal to be euthanized is a piglet of about 3-4 days old.

A1.7 The animal euthanasia device of any of paragraphs A1-A1.5, wherein at least one of the upper left support and the upper right support is adjustably supported relative to the other of the first portion and the second portion so that the distance between the first portion and the second portion is adjustable.

A2 The animal euthanasia device of any of paragraphs A-A1.7, wherein the user input mechanism includes one or more foot pedals positioned to be engaged by a user's foot or feet, wherein in response to a user pressing down on the one or more foot pedals with the user's foot or feet, the animal receiving region is configured from the range of animal receipt configurations to the open configuration, and wherein in response to a user removing the user's foot or feet from the one or more foot pedals, the animal receiving region is configured from the open configuration to the range of animal receipt configurations.

A2.1 The animal euthanasia device of paragraph A2, wherein the one or more foot pedals includes two pedals.

A3 The animal euthanasia device of any of paragraphs A-A1.7, wherein the user-input mechanism includes a linkage assembly, wherein the linkage assembly includes one or more user engagement structures positioned to be engaged by the user and a mechanical linkage supported by the frame and operatively connecting the one or more user engagement structures to the animal receiving region, wherein when the one or more user engagement structures is engaged by the user, the mechanical linkage causes the animal receiving region to reconfigure from the range of animal receipt configurations to the open configuration, and when the user engagement structure is disengaged by the user, the mechanical linkage causes the animal receiving region to reconfigure from the open configuration to the range of animal receipt configurations.

A3.1 The animal euthanasia device of paragraph A3, wherein the one or more user engagement structures includes a foot pedal positioned to be engaged by a user's foot.

A3.2 The animal euthanasia device of any of paragraphs A3-A3.1, wherein the linkage assembly includes one or more springs supported between the frame and the mechanical linkage and that biases the animal receiving region toward the range of animal receipt configurations.

A3.3 The animal euthanasia device of any of paragraphs A3-A3.2, wherein a weight of at least a portion of the animal receiving region at least partially biases the animal receiving region toward the range of animal receipt configurations.

A3.4 The animal euthanasia device of paragraph A3,

wherein the animal receiving region includes an upper left support and an upper right support, wherein the upper left support is configured to engage a first portion of the animal to be euthanized when the animal receiving region is in the range of animal receipt configurations and the animal to be euthanized is received in the animal receiving region, wherein the upper right support is configured to engage a second portion of the animal to be euthanized when the animal receiving region is in the range of animal receipt configurations and the animal to be euthanized is received in the animal receiving region, and wherein the second portion of the animal to be euthanized is spaced from the first portion of the animal to be euthanized;

wherein the mechanical linkage operatively connects the one or more user engagement structures to the upper left support and the upper right support, wherein when the one or more user engagement structures is engaged by the user, the mechanical linkage causes the upper left support and the upper right support to translate upward, thereby reconfiguring the animal receiving region from the range of animal receipt configurations to the open configuration, and when the one or more user engagement structures is disengaged by the user, the mechanical linkage causes the upper left support and the upper right support to translate downward, thereby reconfiguring the animal receiving region from the open configuration to the range of animal receipt configurations.

A3.4.1 The animal euthanasia device of paragraph A3.4, wherein the linkage assembly further includes one or more springs supported between the frame and the mechanical linkage and that biases the upper left support and the upper right support downward and thereby the animal receiving region toward the range of animal receipt configurations.

A3.4.2 The animal euthanasia device of paragraph A3.4.1, wherein the weight of the upper left support and the upper right support further biases the animal receiving region toward the range of animal receipt configurations.

A3.5 The animal euthanasia device of any of paragraphs A3-A3.4.2, wherein the one or more user engagement structures includes two user engagement structures.

A4 The animal euthanasia device of any of paragraphs A-A3.5, wherein the animal receiving region is sized to receive an animal within the range of about 0.25-60 pounds.

A5 The animal euthanasia device of any of paragraphs A-A4, wherein the animal receiving region is sized to receive a piglet of about 3-4 days old.

A6 The animal euthanasia device of any of paragraphs A-A4, wherein the animal receiving region is sized to receive a piglet of less than 3 days old.

A7 The animal euthanasia device of any of paragraphs A-A4, wherein the animal receiving region is sized and configured to receive the animal to be euthanized on its side.

A8 The animal euthanasia device of any of paragraphs A-A7, further comprising:

an enclosure supported by the frame and defining an internal volume, wherein the animal receiving region is at least partially disposed within the enclosure.

A8.1 The animal euthanasia device of paragraph A8, wherein the enclosure includes a door operative between an open position and a closed position, wherein when the door is in the open position, the animal to be euthanized can be positioned in and removed from the animal receiving region, and when the door is in the closed position, the animal to be euthanized is restricted from being positioned in and removed from the animal receiving region.

A8.1.1 The animal euthanasia device of paragraph A8.1, wherein the control system is configured to restrict, when the door is in the open position, current from flowing from the current source through the negative electrode, the positive electrode, and the animal to be euthanized when the animal to be euthanized is received in the animal receiving region and engaged by the positive electrode and the negative electrode.

A9 The animal euthanasia device of any of paragraphs A-A8.1.1,

wherein the control system includes a timer configured to prevent after a predetermined length of time current from flowing from the current source through the negative electrode, the positive electrode, and the animal to be euthanized when the animal to be euthanized is received in the animal receiving region and engaged by the positive electrode and the negative electrode.

A9.1 The animal euthanasia device of paragraph A9, wherein the predetermined length of time is within the range of at least one of about 1-30, 3-5, 3-10, 8-10, 5-15, and 10-15 seconds, or optionally is about 3, 5, 10, 15, or 20 seconds.

A9.2 The animal euthanasia device of any of paragraphs A9-A9.1, wherein the control system further includes a timer adjustment mechanism positioned to be engaged by the user and configured to adjust the predetermined length of time.

A10 The animal euthanasia device of any of paragraphs A-A9.2, wherein the control system includes a switch that restricts current from flowing from the current source through the negative electrode, the positive electrode, and the animal to be euthanized when the animal to be euthanized is received in the animal receiving region and engaged by the positive electrode and the negative electrode regardless of the user engaging the activation mechanism unless a predetermined condition is present.

A10.1 The animal euthanasia device of paragraph A10, further comprising:

an enclosure supported by the frame and defining an internal volume, wherein the animal receiving region is at least partially disposed within the enclosure;

wherein the enclosure includes a door operative between an open position and a closed position, wherein when the door is in the open position, the animal to be euthanized can be positioned in and removed from the animal receiving region, and when the door is in the closed position, the animal to be euthanized is restricted from being positioned in and removed from the animal receiving region; and

wherein the predetermined condition includes the door being in the closed position.

A10.2 The animal euthanasia device of any of paragraphs A10-A10.1, wherein the activation mechanism is a first activation mechanism and the control system further includes a second activation mechanism configured to be engaged by the user, wherein the predetermined condition is both of the first activation mechanism and the second activation mechanism being engaged by the user.

A11 The animal euthanasia device of any of paragraphs A-A10.2, wherein the control system includes a light positioned to be viewed by the user, wherein the control system is configured to illuminate the light when current is permitted to flow from the current source through the negative electrode, the positive electrode, and the animal to be euthanized when the animal to be euthanized is received in the animal receiving region and engaged by the positive electrode and the negative electrode.

A12 The animal euthanasia device of any of paragraphs A-A10.2, wherein the control system includes a light positioned to be viewed by the user, wherein the control system is configured to illuminate the light when current is restricted from flowing from current source through the negative electrode, the positive electrode, and the animal to be euthanized when the animal to be euthanized is received in the animal receiving region and engaged by the positive electrode and the negative electrode.

A13 The animal euthanasia device of any of paragraphs A-A12, wherein the animal euthanasia device is configured to be portable.

A13.1 The animal euthanasia device of paragraph A13, further comprising a plurality of wheels supported by the frame.

A14 The animal euthanasia device of any of paragraphs A-A13.1, wherein the current source is a standard North American 120 Volt AC wall socket.

A15 The animal euthanasia device of any of paragraphs A-A13.1, wherein the current source is a standard European 230 Volt AC wall socket.

A16 The animal euthanasia device of any of paragraphs A-A15, wherein the control system is supported by the frame.

In the event that the provisional patent application that is incorporated by reference herein defined a term in a manner or is otherwise inconsistent with the non-incorporated disclosure of the present application, the non-incorporated disclosure of the present application shall control and the term or terms as used therein only control with respect to the incorporated reference in which the term or terms are defined.

The disclosure set forth above encompasses multiple distinct inventions with independent utility. While each of these inventions has been disclosed in a preferred form or method, the specific alternatives, embodiments, and/or methods thereof as disclosed and illustrated herein are not to be considered in a limiting sense, as numerous variations are possible. The present disclosure includes all novel and non-obvious combinations and subcombinations of the various elements, features, functions, properties, methods and/or steps disclosed herein. Similarly, where any disclosure above or claim below recites “a” or “a first” element, step of a method, or the equivalent thereof, such disclosure or claim should be understood to include one or more such elements or steps, neither requiring nor excluding two or more such elements or steps.

Inventions embodied in various combinations and subcombinations of features, functions, elements, properties, steps and/or methods may be claimed through presentation of new claims in a related application. Such new claims, whether they are directed to a different invention or directed to the same invention, whether different, broader, narrower, or equal in scope to the original claims, are also regarded as included within the subject matter of the present disclosure.

1. An animal euthanasia device, comprising:
a frame;
an animal receiving region supported by the frame and including:
a positive electrode positioned to engage an animal to be euthanized;
a negative electrode spaced apart from the positive electrode and positioned to engage the animal to be euthanized;
wherein the animal receiving region includes an open configuration, in which the animal receiving region is configured to receive the animal to be euthanized, and a range of animal receipt configurations, in which the animal receiving region is configured to restrict movement of the animal to be euthanized;
a user input mechanism supported by the frame and operatively connected to the animal receiving region, wherein in response to user actuation of the user input mechanism the user input mechanism is configured to selectively reconfigure the animal receiving region from within the range of animal receipt configurations to the open configuration to permit a user to position the animal to be euthanized within the animal receiving region and engaged by the positive electrode and the negative electrode, and to selectively reconfigure the animal receiving region from the open configuration to within the range of animal receipt configurations to retrain the animal to be euthanized within the animal receiving region;
a control system configured to be operatively connected to a current source, the control system including an activation mechanism configured to be engaged by the user, wherein in response to the user engaging the user activation mechanism the control system is configured to selectively permit current to flow from the current source through the negative electrode, the positive electrode, and the animal to be euthanized when the animal to be euthanized is received in the animal receiving region and engaged by the positive electrode and the negative electrode.

2. The animal euthanasia device of claim 1, wherein the animal receiving region is biased toward the range of the animal receipt configurations.

3. The animal euthanasia device of claim 1,
wherein the animal receiving region includes:
a lower left support;
an upper left support positioned above the lower left support;
a lower right support; and
an upper right support positioned above the lower right support;
wherein the lower left support and the upper left support are configured to engage a first portion of the animal to be euthanized when the animal receiving region is in the range of animal receipt configurations and the animal to be euthanized is received in the animal receiving region;
wherein the lower right support and the upper right support are configured to engage a second portion of the animal to be euthanized when the animal receiving region is in the range of animal receipt configurations and the animal to be euthanized is received in the animal receiving region, wherein the second portion of the animal to be euthanized is spaced from the first portion of the animal to be euthanized; and
wherein at least one of the lower left support and the upper left support include one of the positive electrode and the negative electrode, and at least one of the lower right support and the upper right support include the other of the positive electrode and the negative electrode.

4. The animal euthanasia device of claim 3,
wherein the lower left support and the upper left support are constructed of a conductive material, are electrically coupled to each other, and collectively define one of the positive electrode and the negative electrode; and
wherein the lower right support and the upper right support are constructed of a conductive material, are electrically coupled to each other, and collectively define the other of the positive electrode and the negative electrode.

5. The animal euthanasia device of claim 3, wherein when the animal receiving region is reconfigured from the open configuration to the range of animal receipt configurations, the upper left support translates toward the lower left support and the upper right support translates toward the lower right support.

6. The animal euthanasia device of claim 3, wherein the lower left support and the lower right support are stationary relative to the frame.

7. The animal euthanasia device of claim 3, wherein one of the first portion and the second portion includes an ear of the animal to be euthanized and the other of the first portion and the second portion includes a rearward most rib of the animal to be euthanized.

8. The animal euthanasia device of claim 7, wherein the animal to be euthanized is a piglet of about 3-4 days old.

9. The animal euthanasia device of claim 1, wherein the user input mechanism includes one or more foot pedals positioned to be engaged by a user's foot or feet, wherein in response to a user pressing down on the one or more foot pedals with the user's foot or feet, the animal receiving region is configured from the range of animal receipt configurations to the open configuration, and wherein in response to a user removing the user's foot or feet from the one or more foot pedals, the animal receiving region is configured from the open configuration to the range of animal receipt configurations.

10. The animal euthanasia device of claim 1, wherein the user-input mechanism includes a linkage assembly, wherein the linkage assembly includes one or more user engagement structures positioned to be engaged by the user and a mechanical linkage supported by the frame and operatively connecting the one or more user engagement structures to the animal receiving region, wherein when the one or more user engagement structures is engaged by the user, the mechanical linkage causes the animal receiving region to reconfigure from the range of animal receipt configurations to the open configuration, and when the one or more user engagement structures is disengaged by the user, the mechanical linkage causes the animal receiving region to reconfigure from the open configuration to the range of animal receipt configurations.

11. The animal euthanasia device of claim 10,
wherein the animal receiving region includes an upper left support and an upper right support, wherein the upper left support is configured to engage a first portion of the animal to be euthanized when the animal receiving region is in the range of animal receipt configurations and the animal to be euthanized is received in the animal receiving region, wherein the upper right support is configured to engage a second portion of the animal to be euthanized when the animal receiving region is in the range of animal receipt configurations and the animal to be euthanized is received in the animal receiving region, and wherein the second portion of the animal to be euthanized is spaced from the first portion of the animal to be euthanized;
wherein the mechanical linkage operatively connects the one or more user engagement structures to the upper left support and the upper right support, wherein when the one or more user engagement structures is engaged by the user, the mechanical linkage causes the upper left support and the upper right support to translate upward, thereby reconfiguring the animal receiving region from the range of animal receipt configurations to the open configuration, and when the one or more user engagement structures is disengaged by the user, the mechanical linkage causes the upper left support and the upper right support to translate downward, thereby reconfiguring the animal receiving region from the open configuration to the range of animal receipt configurations.

12. The animal euthanasia device of claim 11, wherein the linkage assembly further includes one or more springs supported between the frame and the mechanical linkage and that biases the upper left support and the upper right support downward and thereby the animal receiving region toward the range of animal receipt configurations.

13. The animal euthanasia device of claim 1, wherein the animal receiving region is sized and configured to receive the animal to be euthanized on its side.

14. The animal euthanasia device of claim 1, further comprising:
an enclosure supported by the frame and defining an internal volume, wherein the animal receiving region is at least partially disposed within the enclosure;
wherein the enclosure includes a door operative between an open position and a closed position, wherein when the door is in the open position, the animal to be euthanized can be positioned in and removed from the animal receiving region, and when the door is in the closed position, the animal to be euthanized is restricted from being positioned in and removed from the animal receiving region;
wherein the control system is configured to restrict, when the door is in the open position, current from flowing from the current source through the negative electrode, the positive electrode, and the animal to be euthanized when the animal to be euthanized is received in the animal receiving region and engaged by the positive electrode and the negative electrode.

15. The animal euthanasia device of claim 1,
wherein the control system includes a timer configured to prevent, after a predetermined length of time, current from flowing from the current source through the negative electrode, the positive electrode, and the animal to be euthanized when the animal to be euthanized is received in the animal receiving region and engaged by the positive electrode and the negative electrode.

16. The animal euthanasia device of claim 1, wherein the control system includes a switch that restricts current from flowing from the current source through the negative electrode, the positive electrode, and the animal to be euthanized when the animal to be euthanized is received in the animal receiving region and engaged by the positive electrode and the negative electrode regardless of the user engaging the activation mechanism unless a predetermined condition is present.

17. An animal euthanasia device, comprising:
a frame;
an enclosure supported by the frame, defining an internal volume, and including a door operative between an open position and a closed position;
an animal receiving region supported by the frame and disposed at least partially within the internal volume, wherein when the door of the enclosure is in the open position, an animal to be euthanized can be positioned in and removed from the animal receiving region, and when the door of the enclosure is in the closed position, the animal to be euthanized is restricted from being positioned in and removed from the animal receiving region, wherein the animal receiving region includes:
a positive electrode positioned to engage the animal to be euthanized;
a negative electrode spaced apart from the positive electrode and positioned to engage the animal to be euthanized;
wherein the animal receiving region includes an open configuration, in which the animal receiving region is configured to receive the animal to be euthanized, and a range of animal receipt configurations, in which the animal receiving region is configured to restrict movement of the animal to be euthanized, and wherein the animal receiving region is biased toward the range of animal receipt configurations;
a user input mechanism supported by the frame and operatively connected to the animal receiving region, wherein in response to user actuation of the user input mechanism the user input mechanism is configured to selectively reconfigure the animal receiving region from within the range of animal receipt configurations to the open configuration to permit a user to position the animal to be euthanized within the animal receiving region and engaged by the positive electrode and the negative electrode, and to selectively reconfigure the animal receiving region from the open configuration to within the range of animal receipt configurations to retain the animal to be euthanized within the animal receiving region;
a control system configured to be operatively connected to a current source, the control system including an activation mechanism configured to be engaged by the user, wherein in response to the user engaging the user activation mechanism the control system is configured to selectively permit current to flow from the current source through the negative electrode, the positive electrode, and the animal to be euthanized when the animal to be euthanized is received in the animal receiving region and engaged by the positive electrode and the negative electrode, and wherein the control system is configured to restrict, when the door of the enclosure is in the open position, current from flowing from the current source through the negative electrode, the positive electrode, and the animal to be euthanized when the animal to be euthanized is received in the animal receiving region and engaged by the positive electrode and the negative electrode.

18. The animal euthanasia device of claim 17,
wherein the animal receiving region includes:
a lower left support;
an upper left support positioned above the lower left support;
a lower right support; and
an upper right support positioned above the lower right support;
wherein the lower left support and the upper left support are configured to engage a first portion of the animal to be euthanized when the animal receiving region is in the range of animal receipt configurations and the animal to be euthanized is received in the animal receiving region;
wherein the lower right support and the upper right support are configured to engage a second portion of the animal to be euthanized when the animal receiving region is in the range of animal receipt configurations and the animal to be euthanized is received in the animal receiving region, wherein the second portion of the animal to be euthanized is spaced from the first portion of the animal to be euthanized; and
wherein at least one of the lower left support and the upper left support include one of the positive electrode and the negative electrode, and at least one of the lower right support and the upper right support include the other of the positive electrode and the negative electrode.

19. The animal euthanasia device of claim 18,
wherein the lower left support and the upper left support are constructed of a conductive material, are electrically coupled to each other, and collectively define one of the positive electrode and the negative electrode; and
wherein the lower right support and the upper right support are constructed of a conductive material, are electrically coupled to each other, and collectively define the other of the positive electrode and the negative electrode.

20. An animal euthanasia device, comprising:
a frame;
an animal receiving region supported by the frame and including:
a left electrode positioned to engage one of an ear of a piglet of about 3 days old to be euthanized and a portion of the piglet corresponding to a rearward most rib of the piglet;
a right electrode spaced apart from the left electrode and positioned to engage the other of the ear of the piglet and the portion of the piglet corresponding to the rearward most rib of the piglet;
wherein the animal receiving region includes an open configuration, in which the animal receiving region is configured to receive the piglet on its side, and a range of animal receipt configurations, in which the animal receiving region is configured to restrict movement of the piglet on its side;
a user input mechanism supported by the frame and operatively connected to the animal receiving region, wherein in response to user actuation of the user input mechanism the user input mechanism is configured to selectively reconfigure the animal receiving region from within the range of animal receipt configurations to the open configuration to permit a user to position the piglet within the animal receiving region and engaged by the positive electrode and the negative electrode, and to selectively reconfigure the animal receiving region from the open configuration to within the range of animal receipt configurations to retrain the piglet within the animal receiving region;
a control system configured to be operatively connected to a current source, the control system including an activation mechanism configured to be engaged by the user, wherein in response to the user engaging the user activation mechanism the control system is configured to selectively permit current to flow from the current source through the left electrode, the right electrode, and the piglet when the piglet is received in the animal receiving region and engaged by the left electrode and the right electrode.
